(19) United States
(12) Patent Application Publication
(10) Pub. No.: US 2008/0062852 A1
(43) Pub. Date: Mar. 13, 2008

(54) Multi-Dimensional Optical Scanner

(75) Inventors: Alexander Marc Van Der Lee, Eindhoven (NL); Coen Theodoru Hubertus Fransiscus Liedenbaum, Eindhoven (NL); Teunis Willem Tukker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/576,904

(22) PCT Filed: Oct. 13, 2005
(86) PCT No.: PCT/IB05/53364

§ 371 Date: Apr. 9, 2007

(30) Foreign Application Priority Data
Oct. 15, 2004 (EP) 04300681.6

(51) Int. Cl. G11B 7/00

(52) U.S. Cl. 369/112.26

(57) ABSTRACT

The present invention relates to an optical scanning device for reading and/or writing on a plurality of tracks on an optical storage medium (1), said scanning device comprising optical means (17) for focusing a plurality of beams, after being reflected from said medium, onto an observation plane (22), and for introducing astigmatism into at least one of said reflected beams, and a photo-detector (18) comprising a plurality of detector segments, arranged in said observation plane (22) to receive said at least one astigmatic reflected beam. The scanning device further comprises means (19) for generating a focus error signal (FES) by combining signals produced by said detector segments, means (19) for generating a central aperture signal by adding signals from all the detector segments, and means (19, 21) for determining when said central aperture signal exceeds a predefined threshold, indicating a useful range of said focus error signal, and, when this is the case, adjusting the focus of said objective lens (15) based on said focus error signal. According to this design, the CA-signal ensures that tracking is only based on the focus error signal in a range in which tracking can be based on it, thereby ensuring satisfactory closed loop tracking.

### FIELD OF THE INVENTION

The present invention relates to an optical scanner for a multi-dimensional optical storage medium with a focus tracking branch using an astigmatic focus method. The invention also relates to a method for use of such a scanner.

### BACKGROUND OF THE INVENTION

Conventionally, optical storage is performed in one dimension, i.e. a track of consecutive bits is written onto a disc (e.g. CD, DVD). Recently, the concept of two-dimensional optical storage has been introduced. The format of a 2D disc is based on a broad spiral, consisting of a number of parallel bit rows. Parallel read out is realized using a single laser beam, which passes through a diffraction grating producing an array of spots scanning the full width of the broad spiral. Details of such a system is described in “Two-Dimensional Optical Storage”, by Wim M. J. Coene, OSA Topical Meetings on Optical Data Storage, May 11-14, 2003, Technical Digest, pp 90-92, herewith incorporated by reference.

For focus tracking of the laser, a focus error signal can be generated using conventional methods (e.g. Foucault, astigmatic, spot size) applied e.g. on the central spot of the array. However, the small separation between spots (in the order of micrometers) causes the spots to overlap very quickly when out of focus. In the overlap region the intensity profile is highly distorted because of interference from adjacent spots, which disturbs the focus signal. As a result, the capture range, or focus S-curve length, is significantly reduced. While a conventional one dimensional optical reader (e.g. a CD ROM drive) has a capture range of around 5-10 micrometers, a two dimensional reader may have a capture range less than one micrometer. The problem is also present during writing of a disc.

With an astigmatic focus method, to which the present invention is directed, at least one of the reflected beams pass an astigmatic lens, forming an essentially circular image of the spot called the circle of least confusion. Outside this plane, the circle becomes more and more elliptical, to finally be reduced to two orthogonal lines, one before and one after the circle of least confusion. The spot is detected in an observation plane by a quadrant detector, arranged to generate a signal based on the shape of the detected spot, thus indicating any deviation from the circle of least confusion. This focus error signal can be used to adjust the focus of the objective lens to counteract the deviation, thus bringing the detected spot closer to the circle of least confusion. However, due to the small separation between spots mentioned above, in a multidimensional storage system, the elongated spots will overlap except in a very short range around the circle of least confusion, and this small region will be the only useful part of the focus error s-curve, resulting in a very limited capture range of the system.

The patent U.S. Pat. No. 6,229,771 discloses a method for overcoming this problem, by using a diffractive optical element (DOE) for splitting the reflected beams into first and second order beams, which are directed to a data detector array and a focus tracking detector array using the astigmatic method. The orientation of the focal lines of the astigmatic lens, in combination with the shape of the quadrant detectors in the focus tracking array compensate for spot size exceeding the size of the detector and overlap between spots, so that the useful s-curve of the focus error signal is extended.

However, even with the complicated design according to U.S. Pat. No. 6,229,771, the s-curve will be distorted by the interference between beams. It is therefore very difficult to perform satisfactory focus tracking based on such a signal.

### SUMMARY OF THE INVENTION

It is an object of the present invention to overcome this problem, and to provide multi-dimensional optical scanning with improved focus tracking, and in particular an improved capture range.

This and other objects are achieved by a scanning device comprising means for generating a plurality of radiation beams, an objective lens for projecting the beams onto a medium which is intended to reflect the beams, optical means for focusing the beams, after being reflected from the medium, onto an observation plane, and for introducing astigmatism into at least one of the reflected beams, a photo-detector comprising a plurality of detector segments, arranged in the observation plane to receive said at least one astigmatic reflected beam, means for generating a focus error signal by combining signals produced by the detector segments, means for generating a central aperture signal by adding signals from all the detector segments, means for determining when said central aperture signal exceeds a predefined threshold, indicating a useful range of said focus error signal, and, when this is the case, adjusting the focus of said objective lens based on said focus error signal.

According to this design, the CA-signal ensures that tracking is only based on the focus error signal in the range in which tracking can be based on it, thereby ensuring satisfactory closed loop tracking. When the CA-signal is below a given threshold, indicating the spot is out of focus by a given amount, the focus error signal is deemed to be too distorted to provide useful tracking, and tracking is no longer performed based on this signal.

The optical means are preferably adapted to provide astigmatic focal lines separated in the axial direction by a distance z, which is short enough to enable determination of a useful focus error signal at least in a range around a circle of least confusion. In other words, the focus error signal is essentially undistorted by adjacent beams when the beam is almost in focus. The central aperture signal can now be used to select this undistorted range, in which focus tracking can safely be based on the focus error signal.

Most preferably, the optical means are adapted so that the above distance z is smaller than

$$\frac{D}{\sqrt{2} NA} ,$$

where D is the distance between beams in the observation plane and NA is the numeric aperture of the optical means. With such a distance z, the elongated spots will not overlap on the detector segments, thus generating a completely undistorted focus error signal, on which focus tracking can be based. However, as a result of the short distance between focal lines, the spots will become elongated very quickly, and the capture range of the undistorted s-curve will still be extremely short. Outside this capture range a plurality of secondary s-curves will form, and the CA-signal is used to select the “correct” s-curve.

Preferably, when the CA-signal is below the predetermined threshold, adjustment of the objective lens is made according to a predefined schedule, e.g. a predefined incremental step in a predetermined direction. Based on the effect of this adjustment, further adjustment can be made in an open loop tracking procedure, until the CA signal again exceeds the threshold, and the closed loop tracking can be reassumed.

The optical means can be an astigmatic lens, such as a cylindrical lens. This represents a simple and cost efficient implementation, combining the focusing effect and the introduction of astigmatism.

The focus error signal is preferably a characteristic S-curve, crossing zero when the spot is essentially circular (in focus) in the observation plane, reaching a maximum and minimum on each side of the zero crossing for a certain elliptical distortion, and then approaching zero again as the image approaches a line.

Such a focus error signal is advantageously acquired using a photo-detector comprising four adjacent detector quadrants separated by a cross, so that an axis of distortion by said introduced astigmatism extends through the center of said cross and through two oppositely arranged quadrants. Such a detector is known per se, and is advantageously used to determine the extent of astigmatic distortion. This focus error signal is preferably formed as a normalized difference between oppositely arranged pairs of quadrants.

The scanning device preferably comprises optical guiding means for guiding the reflected beams toward said optical means. This branch of the scanner is referred to as the focus tracking branch. The detection of the optical readout can be performed in the same branch, or in a separate detection branch. In the latter case, beams can be guided to this branch by additional optical guiding means.

The above object is also achieved by a method for controlling an optical scanning device, comprising focusing a plurality of beams reflected from said medium onto an observation plane, introducing astigmatism into at least one of said reflected beams, detecting said at least one astigmatic reflected beam in a photo-detector comprising a plurality of detector segments, generating a focus error signal by combining signals produced by said detector segments, generating a central aperture signal by adding signals from all the detector segments, determining when said central aperture signal exceeds a predetermined threshold, and, when this is the case, adjusting the focus of said objective lens based on said focus error signal.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIG. 1 shows the layout of two-dimensional storage on an optical disc,

FIG. 2 shows an optical scanning device in accordance with the invention for parallel read-out of the disc in FIG. 1,

FIG. 3 shows the effect of astigmatism,

FIG. 4 shows the principle of the astigmatic focus method,

FIG. 5 shows a typical focus error signal,

FIG. 6 shows interference from adjacent spots,

FIG. 7a shows two adjacent detectors receiving two distorted beams,

FIG. 7b shows a detail of the diagram in FIG. 3,

FIG. 8 shows en example of a focus error signal and a central aperture signal.

### DETAILED DESCRIPTION OF THE INVENTION

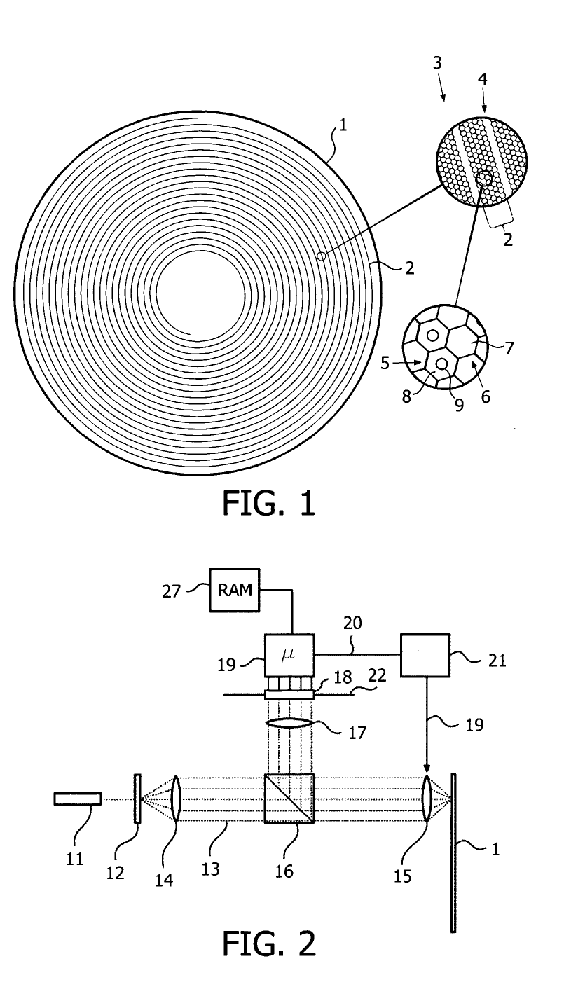

The principles of two-dimensional storage on an optical disc 1 is illustrated in FIG. 1. The information is stored in a broad spiral 2, comprising a number of parallel bit-rows 3, here five rows, and a guard band 4. In the example in FIG. 1, the bit-rows 3 are aligned with each other in the radial direction to form a hexagonal lattice of bits. This means that each bit 5, 6 is associated with a physical hexagonal bit-cell 7, 8. Typically, the bit-cell 7 of a bit with value zero has a uniformly flat area, while a bit-cell 8 for a bit with value one has a hole 9 centrally in the hexagonal area. The size of such a hole 9 is preferably comparable with or smaller than half of the bit-cell area, in order to eliminate signal folding, i.e. a cluster of zeros and a cluster of ones would both result in a perfect mirror.

FIG. 2 shows a schematic setup for reading and/or writing on the disc 1 in accordance with the invention. The setup includes a laser 11 for generating a beam, which passes through a diffraction grating 12 producing an array of beams 13 which are focused onto the disc 1 by a collimator lens 14 and an objective lens 15, to form an array of spots across the entire width of the spiral 2. The objective lens 15 can be moved by an actuator 21 to keep the spots in focus and on a correct radial position on the disc. Each beam 13 is reflected and diffracted by the disc 1, and is then reflected by a beam splitter 16 into a detection branch. The detection branch comprises a lens 17 for focusing the beams onto an observation plane 22, a multi-partitioned photo-detector 18. The photo-detector generates a number of high frequency waveforms, which are provided to a processor 19, where 2D signal processing is used to obtain information from the reflected beams.

In the illustrated example, the detection branch also includes means for focus tracking of the beams, here using the astigmatic method. For this purpose, the processor 19 also provides a focus tracking signal 20 based on one or several of the spots. The focus tracking signal is supplied to the actuator 21, which is operable to adjust the focal length of the objective lens 15, in order to ensure focus tracking of the system. The focus tracking is typically a closed loop system, as the effect of the adjustment immediately influences the value of the tracking signal (feed back).

In order to enable astigmatic tracking, the lens 17 is arranged to introduce astigmatism into the beam, and can be e.g. a cylindrical lens. Alternatively, the astigmatism is introduced by a separate optical element, such as another lens, holographic plates, or in some circumstances (diverging beams) is introduced by the beam splitter 16.

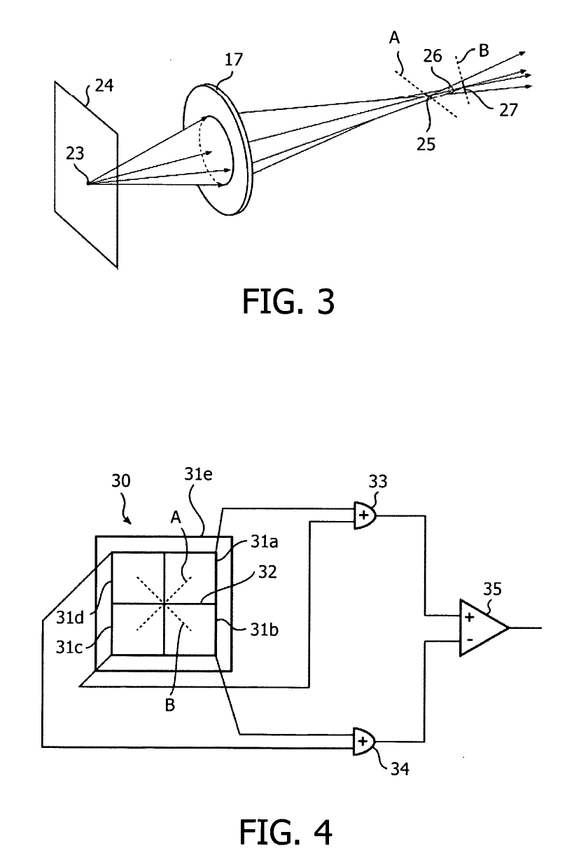

The effect of astigmatism is illustrated in FIG. 3, showing the astigmatic lens 17. The image of a point 23 in an object plane 24 is first circular in cross section, but is then transformed into a primary image in the form of a first line 25 along an axis A. This line then grows into a circular spot 26, called the circle of least confusion, and then finally forms a secondary image in the form of a second line 27 along an axis B orthogonal to the axis A. The lines 25 and 27 are here referred to as focal lines. Between the circle of least confusion and the primary and secondary images respectively, the image has the shape of an ellipse, with its major axis aligned with the axis A and B respectively.

FIG. 4 shows the principles of an astigmatic focus method. At least one of the partitions 30 of the photo detector 17 has four quadrants 31a, 31b, 31c and 31d, arranged so that two, preferably orthogonal dividing lines form a cross 32. The cross is aligned so that the axis A and B of the astigmatic lens 17 extend through two oppositely located quadrants each. The signals from each quadrant, representing the amount of incident light striking this particular quadrant, are combined by forming the sum of oppositely located quadrants (i.e. quadrants along the same axis A or B), and then forming the difference between the two sums. This is schematically indicated in FIG. 4 by two adders 33 and 34, and differential amplifier 35. Of course, alternatively such signal processing is performed by means of software stored in a RAM 28 accessible from the processor 19. In any case, the result is a focus error signal, FES, equal to (Sa+Sc)−(Sb+Sd), where Sx is the signal from quadrant 31x. This sum is typically normalized, i.e. FES=(Sa+Sd)−(Sb+Sd)/(Sa+Sb+Sc+Sd). An alternative FES, with similar characteristics but with improved stability against signal errors, can be formed as (Sa−Sd)/(Sa+Sd)+(Sc−Sb)/(Sb+Sc).

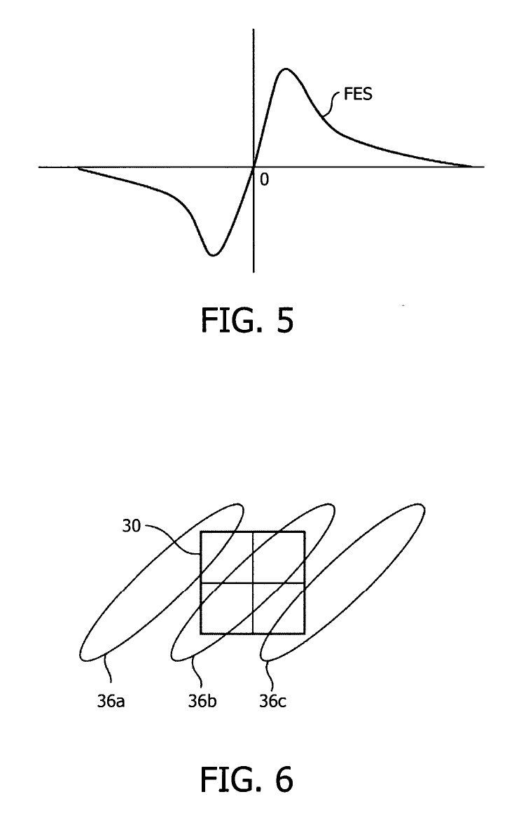

When the symmetrical spot 26 strikes the detector 30, all signals Sx are equal, and the focus error signal is zero. However, when the spot is out of focus, the spot grows more elliptical, causing the segments along one of the axis A or B to receive more light, thus generating greater signals. The value of FES will then increases or decrease, until a maximum is reached, and then approach zero again as the ellipse grows into a line. A typical focus error signal is shown in FIG. 5, and is referred to as a focus s-curve.

As was mentioned above, adjacent spots will disturb the focus error signal, as the spots will overlap when they are out of focus. The situation is illustrated in FIG. 6, where the detector 30 is influenced by the spots 36a, 36b and 36c, and not only 36b, as intended. Consequently, only a small part of the s-curve, when the spot is almost in focus, i.e. in a small range around the zero, will be accurate and useful. This small range will determine the capture range of the focus tracking.

To prevent the closed tracking loop from correcting the objective lens position on a wrong basis, the processor is adapted to determine when the focus error signal FES can be validly used for correcting the objective lens position. To this end, a second signal is generated from the detector 30, formed as the sum of all quadrants 31a-d, i.e. CA=Sa+Sb+Sc+Sd. This signal, called the central aperture signal, or CA signal, will have a maximum when the spot is focused, as no light will miss the detector. When the spot moves out of focus, it grows bigger (the light is more spread out), and some light will miss the detector making the CA signal weaker. The processor is further adapted to compare the CA signal with a predetermined threshold value, and to base the focus tracking signal 20 on the FES only when the CA signal exceeds this threshold. It should be noted that the threshold value depends on the application.

When the CA signal is below the threshold, the processor determines that the objective lens position cannot be efficiently corrected on the basis of the FES s-curve and an open loop correction is achieved. For instance, the actuator 21 moves the objective lens 15 a predetermined step in a predetermined direction. If the CA signal increases, this means that the displacement has been applied in the right direction, if not, the direction should be reversed. The operation is repeated until the CA signal exceeds the threshold, causing the processor 19 to re-activate the closed servo loop.

In an alternative embodiment, the detector 30 comprises an additional detector segment 31e, enclosing the first four quadrants 31a-d. A normalised CA signal CA_{N} can then be calculated as a ratio of the signals from the four quadrants 31a-d and the signals from all segments 31a-e in the following way:
CA_{N}=(Sa+Sb+Sc+Sd)/(Sa+Sb+Sc+Sd+Se),

where again, Sx is the signal from segment 31x.

The processor 19 can then decide to use the focus error signal for correcting the objective lens position if the normalised signal CA_{N} is higher than a second predetermined threshold. An advantage of this alternative is that it indicates how far the spot formed by the isolated reflected sub-beam goes beyond the quadrant detection area of the detector 30. Therefore, the focus error signal can be exploited for all spots with a high enough intensity.

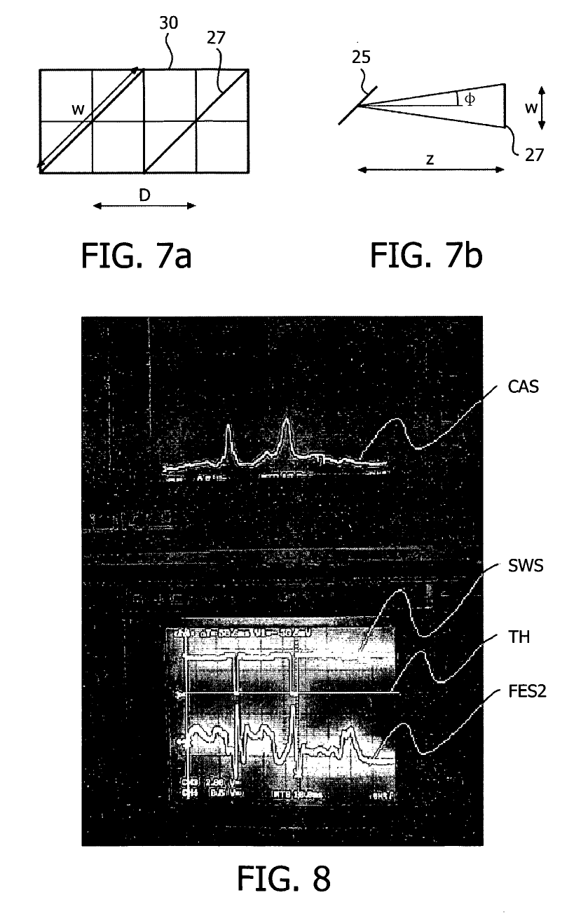

By choosing the distance z between the primary and secondary images of the astigmatism short enough, overlap in the observation plane can be avoided. FIG. 7a shows two adjacent detectors 30, each receiving the primary (or secondary) image of a spot 36, i.e. one of the focus lines 25 or 27. In order to avoid interference in this situation, with the spots being subject to maximum distortion, they must not extend outside the detector. If the distance between spots in the observation plane is D, the maximum allowed extension w of the distorted spots (focal line) is equal to the diagonal of the detector, i.e. w=Dsqrt(2). FIG. 7b shows the area between the two focal lines 25 and 27 in FIG. 3, separated by the distance z. By setting the length of the second line 27 to w, it holds that

$$\frac{w / 2}{z} = tan ( ϕ ) ,$$

where φ is the half-angle of the lens 17. Replacing w with Dsqrt(2) and solving for z results in

$$z = \frac{D}{\sqrt{2} tan ( ϕ )} .$$

It is recalled that a lens is normally defined by its numerical aperture, NA=sin(φ), leading to

$$z = \frac{D}{\sqrt{2} tan ( Arc sin ( NA ) )} ,$$

or approximately

$$z = \frac{D}{\sqrt{2} NA}$$

for small NA (small φ).

Therefore, in a preferred embodiment, the distance z between the primary and secondary images of the astigmatic lens is shorter than the expression above. In a typical system using an astigmatic lens having an NA=0.1, and a distance D between spots in the observation plane 22 in the order of 100 μm, the distance z should be approximately

$$z = \frac{D}{\sqrt{2} NA} ,$$

or in the order of mm or less.

Such a distance z is simply too short to allow the spots to fall out of focus and increase their size enough to cause interference. As a result, the focus error signal is undistorted over the entire s-curve range, and can be used in its entirety. However, at the same time the s-curve is compressed, so that the capture range is not improved. Outside the undistorted s-curve, additional “false” s-curves will appear, and the CA signal is now required to select the correct s-curve. FIG. 8 shows an example of a CA signal (CAS), a switching signal (SW) indicating when the CA signal exceeds a threshold (TH), and a focus error signal (FES). As is clear from the figure, the switching signal switches during periods of a “useful” focus error signal.

The person skilled in the art realizes that the present invention by no means is limited to the preferred embodiments described above. On the contrary, many modifications and variations are possible within the scope of the appended claims. For example, it is preferably only the central partition of the photo-detector 17 that is used for focus signal generation, as it may be advantageous to track on the central beam, but other alternatives are possible, including a plurality of quadrant detectors. It should also be noted that the tracking can be performed in a separate tracking branch, separate from the detection branch. This can simply be realized by implementing a second beam splitter after the beam splitter 16. Each of the detection branch and focus branch will however require separate focusing lenses and detectors. This may be advantageous if different types of detectors are required.

In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. An optical scanning device for reading and/or writing on a plurality of tracks on an optical storage medium (1), said scanning device comprising:
means (11, 12, 14) for generating a plurality of radiation beams (13),
an objective lens (15) for projecting said beams onto said medium, which is intended to reflect said beams,
optical means (17) for focusing said plurality of beams, after being reflected from said medium, onto an observation plane (22), and for introducing astigmatism into at least one of said reflected beams,
a photo-detector (18; 30) comprising a plurality of detector segments (31a, 31b, 31c, 31d), arranged in said observation plane (22) to receive said at least one astigmatic reflected beam,
means (19) for generating a focus error signal (FES) by combining signals produced by said detector segments,
means (19) for generating a central aperture signal (CAS) by adding signals from all the detector segments,
means (19, 21) for determining when said central aperture signal (CAS) exceeds a predefined threshold (TH), indicating a useful range of said focus error signal (FES), and, when this is the case, adjusting the focus of said objective lens (15) based on said focus error signal (FES).

2. An optical scanning device according to claim 1, wherein said optical means (17) are adapted to provide astigmatic focal lines (25, 27) separated in the axial direction by a distance (z) which is short enough to enable determination of a useful focus error signal at least in a range around a circle of least confusion.

3. An optical scanning device according to claim 2, wherein said distance (z) is smaller than D/\sqrt{2}NA, where D is the distance between beams in the observation plane (22) and NA is the numeric aperture of the optical means (17).

4. An optical scanning device according to claim 1, further comprising means (19, 21) for adjusting the focus of said objective lens (15) a predetermined amount in a predetermined direction, when said central aperture signal is below said predetermined threshold (TH).

5. An optical scanning device according to claim 1, wherein said optical means is an astigmatic lens, such as a cylindrical lens.

6. An optical scanning device according to claim 1, wherein said focus error signal (FES) passes zero when said astigmatic reflected beam has an essentially circular section in the observation plane (22).

7. An optical scanning device according to claim 1, wherein said photo-detector (30) comprises four adjacent detector quadrants (31a, 31b, 31c, 31d) separated by a cross (32), so that an axis of distortion (A, B) by said introduced astigmatism extends through the center of said cross (32) and through two oppositely arranged quadrants (31a, 31c; 31b, 31d).

8. An optical scanning device according to claim 1, further comprising optical guiding means (16) for guiding the reflected beams toward said optical means (17).

9. A method for controlling an optical scanning device for a multi dimensional optical storage medium, comprising the steps of:
focusing a plurality of beams reflected from said medium onto an observation plane (22),
introducing astigmatism into at least one of said reflected beams,
detecting said at least one astigmatic reflected beam in a photo-detector (18; 30) comprising a plurality of detector segments (31a, 31b, 31c, 31d),
generating a focus error signal (FES) by combining signals produced by said detector segments,
generating a central aperture signal (CAS) by adding signals from all the detector segments,
determining when said central aperture signal (CAS) exceeds a predetermined threshold (TH) indicating a useful range of said focus error signal, and, when this is the case, adjusting the focus of said objective lens (15) based on said focus error signal (FES).

10. A method according to claim 9, further comprising ensuring that said focus error signal is essentially undistorted in a range between the astigmatic focal lines (25, 27).

11. A method according to claim 9, further comprising adjusting the focus of said objective lens (15) a predetermined amount in a predetermined direction, when said central aperture signal is below said predetermined threshold (TH).
